(19) United States
(12) Patent Application Publication
(10) Pub. No.: US 2011/0130120 A1
(43) Pub. Date: Jun. 2, 2011

(54) GENERATION OF A TIME-DEPENDENT PASSWORD, PARTICULARLY IN A MOBILE COMMUNICATION DEVICE

(75) Inventors: Sebastiaan Hoeksel, Maastricht (NL); Najib Koraichi, Schimmert (NL); Patrick H. Waters, Redlynch Salisbury (GB)

(73) Assignee: Vodafone Holding GmbH, Dusseldorf (DE)

(21) Appl. No.: 12/842,416

(22) Filed: Jul. 23, 2010

(30) Foreign Application Priority Data
Dec. 1, 2009 (EP) 09 014 877.6

(51) Int. Cl. H04M 1/66

(52) U.S. Cl. 455/411; 455/558

(57) ABSTRACT

There is provided a mobile communication device. An exemplary mobile communication device comprises a terminal. The exemplary mobile communication device also comprises a smartcard connected to the terminal, the smartcard comprising a power source and a clock unit that can be supplied with power by the power source. The exemplary mobile communication device additionally comprises a processing unit adapted to generate a time-dependent password based on a time signal from the clock unit.

### CROSS REFERENCE TO RELATED APPLICATION

This application claims priority to European (EP) Patent Application No. 09 014 877.6, filed on Dec. 1, 2009, the contents of which are incorporated by reference as if set forth in their entirety herein.

### BACKGROUND

Conventional static passwords bear the risk to be discovered by unauthorized third parties. Protection against unauthorized access to restricted resources can be improved by using so-called one-time passwords (OTPs), which are valid only for one time. An OTP mechanism, commonly referred to as time-synchronized type OTP, involves synchronized time information for generating and validating OTPs. At regular time intervals, such as, for example, every minute, a security device or an application, which is usually called “token”, generates a new OTP from current time information and a secret key assigned to the user. For validating the OTP, an authorization station re-generates the OTP based on the secret key and own current time information using the same algorithm as the token and compares the self-generated password with the password generated by the token.

The token may be a closed, tamper-resistant hardware system dedicated to the generation of OTPs, which stores the secret key of the user and which usually has a built-in clock for providing the time information. As an alternative, the token may be configured as a so-called “soft token”, which is a software application run on a general-purpose processor.

WO 2007/126227 describes a mobile communication device, such as, for example, a mobile phone, a PDA (Personal Data Assistant) or the like, which has an interface for accepting an IC chip (IC: Integrated Circuit) for generating time-synchronized type OTPs. The IC chip stores the users secret key and comprises a module for generating the OTPs. The time information is provided by a base station and received by the radio frequency processing unit of the mobile communication device.

The IC chip allows for implementing the token for generating time-synchronized type OTPs in a mobile communication device. However since an external time signal provides the time information for generating the OTPs, the time information is available only if the mobile communication device is connected to the base station. This means that the generation of OTPs is not possible, if the mobile communication device cannot be connected to the base station.

### SUMMARY

Exemplary embodiments of the invention relate to the generation of time-dependent passwords, particularly to the generation of time-synchronized one-time passwords. More specifically, the invention relates to a mobile communication device and to a smartcard for generating a time-dependent password. The invention further relates to a method for generating a time-dependent password in a mobile communication device.

An exemplary embodiment may allow for generating time-synchronized OTPs in a mobile communication device also when the device is not connected to the network.

In one exemplary embodiment, a mobile communication device comprises a terminal and a smartcard connected to the terminal. The mobile communication device also comprises a processing unit adapted to generate a time-dependent password. The smartcard includes a power source and a clock unit, which can be supplied with power by the power source, and the processing unit is adapted to generate the time-dependent password based on a time signal from the clock unit.

A smartcard for use in a mobile communication device may also be provided, according to an exemplary embodiment. The smartcard comprises a processing unit adapted to generate a time-dependent password and it comprises a power source and a clock unit, which can be supplied with power by the power source. The processing unit is adapted to generate the time-dependent password based on a time signal from the clock unit.

A method according to an exemplary embodiment relates to generating a time-dependent password in a mobile communication device. In the exemplary method, the time-dependent password is generated in a processing unit based on a time signal from a clock unit, the clock unit being included in a smartcard of the mobile communication device and supplied with power by a power source included in the smartcard.

One exemplary embodiment relates to providing the mobile communication device with an internal clock to provide time information for generating a time-dependent password independently of an external time signal received in the mobile communication device. The clock unit may be integrated into a smartcard of the mobile communication device. Thereby, the clock unit is protected by the secure architecture of the smartcard so that tampering with the time information is prevented.

In order to enable the clock unit to continuously measure time, it may be powered by an internal power source of the smartcard. Thus, the clock unit can still be run, when the external power supply of the smartcard (i.e., the power supply from the terminal) is interrupted, which is usually the case, when the terminal is turned off. Thus, the clock unit can be configured as an essentially autarkic system, which provides tamper-resistant time information.

In one exemplary embodiment of the mobile communication device, the smartcard and the method, the power source can be charged from the terminal, when the terminal is turned on. In this embodiment, the power source may be a battery, for example. Advantageously, it can be recharged from the terminal so that exhaustion is prevented and the lifetime of the power source is increased.

In a further exemplary embodiment of the mobile communication device, the smartcard and the method, the processing unit generating the OTP is included in the smartcard. In particular, the processing unit may be a microcontroller of the smartcard executing an application for generating the OTP. By including the processing unit in the smartcard, it can likewise be secured against tampering by the secure hardware environment of the smartcard and its microcontroller. As an alternative, it is likewise possible to include the processing unit in the terminal of the mobile communication device.

The clock unit may be a sealed system measuring time independent from external devices or signals. This may provide an enhanced level of security. However, in a further exemplary embodiment of the mobile communication device, the smartcard and the method, the smartcard may be adapted to receive an external time signal and to synchronize the clock unit and the time signal. This allows compensating for clock drift and resetting the clock in case of a possible exhaustion of the battery.

The smartcard may try to synchronize the clock unit regularly or triggered by predefined events. However, the external time signal may not be available all the time. In particular, it may be received via a communication network to which the mobile communication device can be connected. Thus, synchronization may only be possible when the mobile communication is connected to the network. However, usually the connection to the network is available sufficiently frequently so that a high accuracy of the clock unit can be achieved continuously.

In order to set or adjust the clock unit when the external time signal is available, the smartcard may be adapted to check, whether the external time signal is accessible, and to synchronize the clock unit and the time signal, when it is determined that the external time signal is accessible.

In a further exemplary embodiment of the mobile communication device, the smartcard and the method, the smartcard comprises a user identification module for identifying and/or authenticating a subscriber to a mobile communication network to which the mobile communication device can be connected. In mobile communications, such user identification modules are usually provided in smartcards which are connected to user terminals in order to use the terminals in a mobile communication network. By including the clock unit into such a smartcard further advantage can be taken of its existing security architecture. Thus, a secured clock unit can be provided without having to provide an additional complex secure hardware environment.

Furthermore, in one exemplary embodiment of the mobile communication device, the smartcard and the method, the processing unit is unlocked for generating the time-dependent password after an authorization code entered by a user for the mobile communication device is verified successfully. Thus, it is prevented that an unauthorised person uses the mobile communication device or the smartcard to generate a time-dependent password. The authorization code may be a PIN (Personal Identification Number), for example. It may be an authorization code allocated to the generation of time-dependent passwords. In this case, the authorization code may particularly be the secret key used for computing one-time password. As an alternative the authorization code may be a code used for unlocking the smartcard or the user identification module included in the smartcard. In this embodiment, it can be relied on the security mechanism of the user identification module to unlock the processing unit for the generation of a time-dependent password.

### BRIEF DESCRIPTION OF THE DRAWINGS

The aforementioned and other aspects of the invention will be apparent from and elucidated with reference to the embodiments described hereinafter making reference to the accompanying drawings.

FIG. 1 is a block diagram of a communication system comprising a mobile communication device for generating a time-dependent password; and

FIG. 2 is a block diagram of a smartcard for use in a mobile communication device, the smartcard comprising a clock unit for providing current time information.

### DETAILED DESCRIPTION OF SPECIFIC EMBODIMENTS

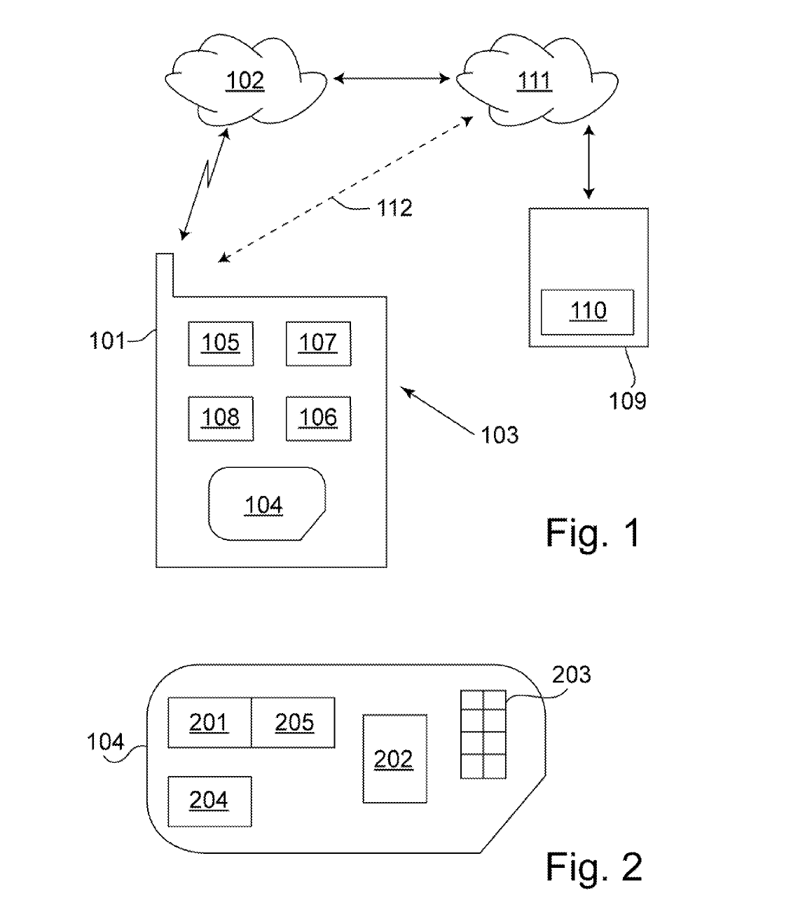

FIG. 1 shows a mobile communication device 101, which can be connected to a mobile communication network (PLMN—Public Land Mobile Network) 102, which may be configured according to the GSM or UMTS standard, for example (GSM: Global System for Mobile Communications; UMTS: Universal Mobile Telecommunications System). The mobile communication device 101 includes a terminal 103 and a smartcard 104.

The terminal 103 comprises those components of the mobile communication device 101 which do not belong to the smartcard 104. For connecting the mobile communication device 101 to the PLMN 102, the terminal 103 comprises a radio interface 105. The radio interface 105 is coupled to a processor 106 of the terminal 103. For interacting with the mobile user, the terminal 103 comprises a user interface 107, which may include one or more input components and one or more output components and which is coupled to the processor 106. For supplying the components of the terminal 103 and also the smartcard 104 with power, the terminal 103 comprises a power source 108, which may be configured as a rechargeable battery.

The terminal 103 interacts with the smartcard 104, which can be inserted into a card reader unit of the terminal 103, which is not shown in FIG. 1. The smartcard 104 comprises an identification module allocated to a subscription of the mobile user to the PLMN 102. The identification module includes information for identifying and/or authenticating the subscribed user to the PLMN 102 and provides functionality for accessing services of the PLMN 102. The subscriber identification module may be configured in accordance with the type of the PLMN 102. If the PLMN 102 is a GSM or UMTS network, the subscriber identification module is a Subscriber Identity Module (SIM) according to the GSM standard or a Universal Subscriber Identity Module (USIM) according to the UMTS standard.

The user of the mobile communication device 101 has the authorization to access a restricted resource of a host device 109. The host device 109 may be a computer and/or a web server and the restricted resource may be information and/or an application provided by the host device 109. To the host device 109 an authorization unit 110 is assigned, which may be integrated into the host device 109. The authorization unit 110 denies access to the restricted resource of the host device 109 unless the user is identified and authenticated successfully. The user authorization in the authorization unit 110 is performed using time-synchronised OTPs so that a high level of security of the access control is achieved.

For generating time-synchronised OTPs, the mobile communication device 101 comprises an OTP application. The OTP application may be resident in the terminal 103 and run on the terminal's processor 106. In a different embodiment, the OTP application is resident in the smartcard 104 including the subscriber identification module. This has the advantage that the OTP application is secured against unauthorized access by the security mechanism of the smartcard 104. In further embodiments, an OTP chip including the OTP application may be removably connected to the terminal 103.

In one embodiment, which is depicted in FIG. 1, a communication connection can be established between the authorization unit 110 and the mobile communication device 101. Via this communication connection an OTP generated in the mobile communication device 101 can be transmitted electronically to the authorization unit 110 for verification, when the mobile user wishes to access the restricted resource of the host device 109.

As shown in FIG. 1, the communication connection may be established via a data network 111, such as, for example, the Internet, to which the authorization unit 110 is connected. The mobile communication device 101 may be connected to the data network 111 using a suitable access technology, such as, for example, a WLAN connection. In FIG. 1, this is schematically illustrated by a dashed arrow 112. As an alternative, the mobile communication device 101 may be connected directly to the authorization unit 110, or the PLMN 102 may be coupled to the data network 111, such that the communication connection between the mobile communication device 101 and the authorization unit 110 can be established via the PLMN 102 and the data network 111, if the mobile communication device 101 is registered in the PLMN 102.

In a further embodiment, the OTP application outputs generated OTPs at the user interface 107 of the mobile communication device 101. The user reads that generated password at a display component of the user interface 107 and enters the password at the apparatus used for accessing the restricted resource.

The mobile user may access the restricted resource of the host device 109 using the mobile communication device 101. For this purpose, the mobile communication device 101 may be connected to the host device 109 in the same way as to the authorization unit 110, i.e. via the data network 111 and/or via the PLMN 102. In particular, the host device 109 may be accessed via the authorization unit 110 through the network 111 or a direct connection described before. In this case, it is especially advantageous to transmit the OTP to the authorization unit 110 electronically. In another embodiment, the mobile user accesses the host device 109 either directly via a user interface of the host device 109 or using a further device, such as for example a personal computer an/or a notebook computer, which is connected to the host device 109 directly or via the data network 111. In this embodiment, the OTP may either be transmitted from the mobile communication device 101 to the authorization unit 110 electronically or the OTP may be input by the mobile user.

The OTP application may provide a graphical user interface at a display component of the user interface 107 of the mobile communication device 101 for depicting outputs and for presenting input requests to the user. In particular, the OTP may be presented in the graphical user interface, when it is read by the user to input it into the device used for accessing the restricted resource. Moreover, the OTP application is configured to receive user inputs from an input component of the user interface 107. If the OTP application resides in the smartcard 104, the OTP application may access the functionalities of the mobile communication device 101 using SIM Toolkit commands, which, in general, are known to a person skilled in the art.

For generating time-synchronised OTPs, an algorithm is implemented in the OTP application, which is used to calculate OTPs based on time information and a secret key allocated to the user. The secret key may be a personal identification number (PIN), for example. The secret key may be entered by the user, when the OTP application is started or when the user requested the generation of a password. Likewise, it is possible that the secret key is stored securely in the mobile communication device 101, particularly in the smartcard 104.

Before a password is generated, the user may be required to unlock the OTP application. If the secret key is entered by the user, this may correspond to the unlocking procedure for the OTP application. Alternatively, the OTP application may be unlocked only after a further authorization code entered by the user has been validated successfully by the OTP application. This is especially advantageous, if the secret key for generating OTP is stored in the mobile communication device 101. The authorization code may be another PIN and differ from the secret key allocated to the user in that the secret key is used to calculate the passwords, while the authorization code is used to unlock the password generation. It may be allocated to the OTP allocation. In another embodiment, the OTP application is unlocked together with the user identification module of the SIM, which is usually also done based on an authorization code entered by the user upon turning on the mobile communication device 101. Securing the OTP application with an authorization code for unlocking the password generation has the advantage that an attacker has to use the mobile communication device 101 for generating passwords of the user, since the secret key is secured against access within the mobile communication device 101.

For validating the password generated by the OTP application, the authorization unit 110 re-computes the passwords using the users secret key, which is also stored in the authorization station 110, and its own time information. The time information used by the OTP application and the time information present in the authorization unit 110 have to be synchronised accurately enough. Usually, the authorization unit 110 allows for generating passwords computed using time information with a predetermined deviation from the time information present in the authorization unit 110. For this purpose, the authorization unit 110 may determine that the password is valid, if it is calculated using a time from a predetermined time interval around the current time of the authorization unit 110. The time interval may be between 0.5 and 15 minutes.

The OTP application can retrieve the time information needed for generating the time-synchronised OTPs from a clock unit 201 included in the smartcard 104. As is shown in FIG. 2, the smartcard 104 comprises a microcontroller 202, which includes a programmable processor unit for executing software applications and a memory for storing reference data and program code that is executable in the processor unit. An external interface 203 is provided, which allows for a data exchange between the microcontroller 202 and an external device. Moreover, power can be supplied to the smartcard 104 from the external device via the external interface 203. The external device is the terminal 103 of the mobile communication device 101, when the smartcard 104 is inserted therein.

The microcontroller 202 provides a secure environment for the execution of application and the storage of data. Particularly, this means that unauthorized access to data and processes is prevented due to the hardware design of the microcontroller 202 and due to cryptographic mechanisms used for managing data in the microcontroller 202. Moreover, the microcontroller 202 is integrated into a secure hardware environment provided by the smartcard 104, which is physically protected against manipulations, such as power analysis, reverse engineering etc. The microcontroller 202 may provide the subscriber identification module of the smartcard 104 and it may also store and execute the OTP application, when it is not executed in the terminal 103 of the mobile communication device 101. Thus, the OTP application is secured against tampering by the security features of the smartcard 104 and its microcontroller 202.

In addition, the smartcard 104 includes the clock unit 201 that may comprise an electronic oscillator, which may be regulated by a quartz crystal, for example. The clock unit 201 is continuously measuring time so that current time information can always be provided. Preferably, it generates absolute time information, which can be used by the OTP application for calculating OTPs. However, it is likewise possible that the clock unit 201 generates time information relative to a specific point in time. In this case, the OTP application or another component of the smartcard 104 or the terminal 103 may convert the relative time information provided by the clock unit 201 into absolute time information to calculate OTPs. As the microcontroller 202, the clock unit 201 is integrated into the secure hardware environment of the smartcard 104. Thus, tampering of the time information can be prevented. Additionally, the clock unit 201 may itself be protected against tampering by suitable measures.

In order to be able to continuously measure time, the clock unit 201 is continuously supplied with power. However, the external power supply of the smartcard 104 is interrupted each time the terminal 103 is turned off. Therefore, the clock unit 201 can be supplied with power by a power source 204 of the smartcard 104.

Preferably, the power source 204 is integrated into the body of the smartcard 104 together with the microcontroller 202 and the clock unit 201 without enlarging the dimensions of the smartcard 104, which are determined by a standardized format. The power source 204 may be a rechargeable battery comprising one or more battery cells. The battery is small and thin enough to be integrated into the body of the smartcard 104. For instance, the power source 204 may be a foil battery, a RHISS battery (RHISS: Rechargeable Hydrogen Ion Solid State) or a thin-film battery.

Preferably, the power source 204 can be charged by connecting it to the power circuit of the terminal 103 via the external interface 203 of the smartcard 104, while the smartcard 104 is supplied with power by the terminal 103. Thus, in the usual use of the mobile communication device 101, the power source 204 can be charged regularly from the power source 108 of the terminal 103. Preferably, the charging is controlled by a power management unit of the microcontroller 202 of the smartcard 104. The power management unit may dispose of a mechanism to determine the state-of-charge of the power source 204, and if it is judged that the capacity of the power source 204 is below a predetermined threshold, charging is done (the microcontroller 202 may be supplied with power by the terminal 103 so that the power supply by the terminal 103 is always available, when the power management unit is operating).

The clock unit 201 may be supplied with power exclusively by the power source 204 of the smartcard 104. As an alternative, the clock unit 201 may be supplied with power by the power source 204 only when the external power supply of the smartcard 104 is not available, i.e. when the terminal 103 is turned off. When the terminal 103 is turned on and supplies power to the smartcard 104, the clock unit 201 may be supplied with power by the terminal 103 via the external interface 203 of the smartcard 104. For this purpose, the power management unit of the smartcard 104 may be configured to switch the power supply to a supply via the external interface 203 of the smartcard 104, when it is determined that the terminal 103 is operating. This may be done by connecting the clock unit 201 to the power terminal of the external interface 203. When the power management unit determines that the terminal 103 is switched off, it connects the clock unit 201 to the internal power source 204 of the smartcard 104 so that the power source 204 supplies the clock unit 201 with power.

The clock unit 201 may be set once at the time of manufacture of the smartcard 104. Then, it may be sealed in order to prevent tampering so that a very high degree of security is achieved and no external time information is required. However, in another embodiment, a control unit 205 is assigned to the clock unit 201 which is configured to set the clock unit 201 after issuance of the smartcard 104. This allows for adjusting the clock unit 201 to compensate for clock drift and it allows for resetting the clock unit 201 in case of possible battery exhaustion.

The clock unit 201 may be set using an external time signal, which may be received via the PLMN 102. For this purpose, the PLMN 102 may provide a service for retrieving time information. In one embodiment, the service may be accessed using so-called USSD commands (USSD: Unstructured Supplementary Service Data), which are, in general, known to a person skilled in the art. As an alternative, the time signal may be received from a predefined time server in the PLMN 102 or in the data network 111. The time server may be synchronized with the time information used in the authorization unit 110, so that it is guaranteed that synchronised time information is used for generating and verifying OTPs. Thus, even when the mobile communication device 101 is located in another time zone than the authorization unit 110, correct time information is available (in this case, the clock unit 201 may also measure the time used in the authorization and not the local time).

The control unit 205 may retrieve external time information via the terminal 103 at regular time intervals or triggered by predetermined events, such as, for example, a user interaction, and synchronizes the clock unit 201 with the external time information. Thus, the clock unit 201 can be adjusted regularly, when the mobile communication device 101 is connected to the PLMN 102. In order to avoid the issuance of a command for retrieving the external time information when the mobile communication device 101 is not connected to the PLMN 102, the control unit 205 may check, whether the mobile communication device 101 is connected to the PLMN 102, before issuing the command. This may be done by checking, whether a predetermined data signal broadcasted in the PLMN 102 is received in the mobile communication device 101, such as, for example, a signal identifying the PLMN 102 that is broadcasted in the PLMN 102 in regular time intervals. The command for retrieving the external time information may be issued only when it is determined that such a broadcasted signal is received.

In order to prevent the clock unit 201 from being tampered with using a manipulated external time signal, the time information may be encrypted and/or accompanied by a security feature, such as, for example, a digital signature of the time server. The security feature of the time information may be verified in the control unit 205 before setting the clock unit 201. Moreover, the control unit 205 may compare currently received time information with the time information received before and checks, whether the time information received before indicate a point of time in the past relative to the currently received time information. If this comparison was successful, the control unit 205 sets the clock unit 201 using the currently received time information. Otherwise an alarm routine may be started.

In one embodiment, the OTP application exclusively uses the time information provided by the clock unit 201 for generating OTPs. This has the advantages that time information is always provided to the OTP application in the same way and that attacks using a manipulation of external time information can be prevented. In an alternative embodiment, the processing unit executing the OTP application is adapted to check, if external time information is available and the OTP is computed using the external time information, if it is available. This means that time signal of the clock unit 201 is only used, when the external time signal is not available, i.e. when the mobile communication device 101 is connected to the PLMN 102. If the mobile communication device 101 is registered in the PLMN 102, the OTP application may use the external time information retrieved via the PLMN 102 to calculate the OTP. For this purpose, the OTP application may try to retrieve external time information via the PLMN 102 at first, when the OTP is to be generated. When external time information is available, the OTP application may use this time information to generate the OTP. If the external time information cannot be received, the OTP application may retrieve time information from the clock unit 201 to generate the OTP.

While the invention has been illustrated and described in detail in the drawings and foregoing description, such illustration and description are to be considered illustrative or exemplary and not restrictive; the invention is not limited to the disclosed embodiments. In particular, the invention is not limited to the use of smartcards 101 comprising a user identification module; rather other smartcards can also be used when effecting the invention. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single processor or other unit may fulfill the functions of several items recited in the claims. A computer program may be stored/distributed on a suitable medium, such as an optical storage medium or a solid-state medium supplied together with or as part of other hardware, but may also be distributed in other forms, such as via the Internet or other wired or wireless telecommunication systems.

Any reference signs in the claims should not be construed as limiting the scope.

What is claimed is:

1. A mobile communication device, comprising:
a terminal;
a smartcard connected to the terminal, the smartcard comprising a power source and a clock unit that can be supplied with power by the power source; and
a processing unit adapted to generate a time-dependent password based on a time signal from the clock unit.

2. The mobile communication device recited in claim 1, wherein the power source can be charged from the terminal when the terminal is turned on.

3. The mobile communication device recited in claim 1, wherein the power source comprises a rechargeable battery.

4. The mobile communication device recited in claim 1, wherein the processing unit is included in the smartcard.

5. The mobile communication device recited in claim 1, wherein the smartcard is adapted to receive an external time signal and to synchronize the clock unit and the time signal.

6. The mobile communication device recited in claim 5, wherein the external time signal is provided via a communication network to which the mobile communication device can be connected.

7. The mobile communication device recited in claim 5, wherein the smartcard is adapted to check, whether the external time signal is accessible, and to synchronize the clock unit and the time signal, when it is determined that the external time signal is accessible.

8. The mobile communication device recited in claim 1, wherein the smartcard comprises a user identification module for identifying and/or authenticating a subscriber to a mobile communication network to which the mobile communication device can be connected.

9. The mobile communication device recited in claim 1, wherein the processing unit is unlocked for generating the time-dependent password after an authorization code entered by a user for the mobile communication device is verified successfully.

10. A smartcard for use in a mobile communication device, the smartcard comprising:
a power source;
a clock unit, which can be supplied with power by the power source, the clock unit being adapted to generate a time signal; and
a processing unit adapted to generate a time-dependent password based on the time signal.

11. A method for generating a time-dependent password in a mobile communication device, the method comprising:
supplying a smartcard of the mobile communication device with power from a power source included in the smartcard, the smartcard including a clock unit that generates a time signal; and
generating the time-dependent password in a processing unit based on the time signal.
